(19) United States
(12) Patent Application Publication
(10) Pub. No.: US 2017/0353350 A1
(43) Pub. Date: Dec. 7, 2017

(54) SOFTWARE UPDATING DEVICE AND TRANSMISSION SYSTEM FOR A MOTOR VEHICLE

(71) Applicant: Ford Global Technologies, LLC, Dearborn, MI (US)

(72) Inventors: Uwe GUSSEN, Huertgenwald NRW (DE); Frederic STEFAN, Aachen NRW (DE); Christoph ARNDT, Moerlen Rheinland-Pfalz (DE)

(73) Assignee: Ford Global Technologies, LLC, Dearborn, MI (US)

(21) Appl. No.: 15/609,994

(22) Filed: May 31, 2017

(30) Foreign Application Priority Data
Jun. 2, 2016 (DE) 102016209682.6

(51) Int. Cl. H04L 12/24; H04L 29/08; H04B 10/11

(52) U.S. Cl. CPC H04L 41/082; H04B 10/11; H04L 67/12

(57) ABSTRACT

A method and associated devices are used for updating software of a motor vehicle by transmitting software-updating data via LiFi. A traffic management system includes a plurality of LiFi-enabled transceiver modules and a LiFi-enabled transceiver module of the motor vehicle. During the operation of the motor vehicle in road traffic, the software-updating data of at least one of the LiFi-enabled transceiver modules of the traffic management system are transmitted to the LiFi-enabled transceiver module of the motor vehicle located within a transmission range of the transceiver module.

### CROSS-REFERENCE TO RELATED APPLICATIONS

This application claims foreign priority benefits under 35 U.S.C. §119(a)-(d) to DE Application 10 2016 209 682.6 filed Jun. 2, 2016, which is hereby incorporated by reference in its entirety.

### TECHNICAL FIELD

The present disclosure relates to a method and an updating device for updating software of a motor vehicle via LiFi during an operation of the motor vehicle. The disclosure also relates to a transmission system for transmitting software-updating data via LiFi to a motor vehicle.

### BACKGROUND

Many driver assistance systems are already integrated into motor vehicles. Along with the driver-supporting assistance systems, more and more infotainment systems are being integrated into a modern motor vehicle. Each individual information system is controlled via its own software. These software data are stored in the motor vehicle and are separated from the data streams located outside the motor vehicle. An update or upgrade of one of these software programs is possible only if the software is connected to the data streams outside the motor vehicle. Connections of this type are typically established in a workshop, usually via a cable. One consequence for the driver of a motor vehicle is that he must visit a workshop whenever the software of one of the motor vehicle components needs to be updated. However, this is different in the case of software bug fixes or other minor updates which do not directly affect the driver. The situation is further aggravated by the fact that some of these information systems relate to safety systems of the vehicle, and, therefore, leave the driver of the motor vehicle little scope to avoid the software update. The transmission control or the battery management of an electrically driven vehicle or a hybrid vehicle can be cited as examples here. The vehicles of these two aforementioned vehicle categories could receive a plurality of updates for new functions or characteristics of the software of the individual motor vehicle components during their life cycle, particularly for systems relating to fuel efficiency.

At the present time, it is increasingly important to carry out the updates of software of a motor vehicle component in real time or very promptly. With the current 150 electronic control units (assistance and safety systems) in a modern motor vehicle, it would cost the customer a great deal of time to have the update or upgrade of the software carried out in real time for each individual electronic control unit at a dealership or in a workshop.

The present disclosure seeks to avoid the approach of taking the vehicle to the workshop or dealership for the software update. The updating of the software of a motor vehicle component without visiting a dealership or workshop and using a wireless connection would satisfy the currently increasing desire of customers for a real-time update of the software of individual motor vehicle components.

The software for the individual motor vehicle components is currently installed directly in the factory, in an assembly line. The software data are typically transmitted here by means of a cable. A transmission by means of on-air technology is not usually possible without substantial expense. Electromagnetic interference fields can be cited as the main cause here. A first idea of transmitting the software data onto the motor vehicle for the individual motor vehicle components via LiFi is disclosed in DE 10 2013 018 363 A1. DE 10 2013 018 363 A1 discloses a method for data transmission for the configuration of a motor vehicle during the motor vehicle production. This method improves known methods in that an even more efficient and faster configuration of motor vehicles in an assembly line is possible. In the aforementioned it is proposed, for the configuration of a control unit in a motor vehicle, to transmit information or data by means of electromagnetic radiation or light into the motor vehicle as the receiver. The data are received by the motor vehicle via existing sensors. The data are transmitted via a transmitting device integrated into the production line.

The use of LiFi for transmitting data to or from a motor vehicle is already disclosed in a plurality of prior art documents. JP 5804490 B2 and CN 101419069 A can be cited here.

The use of LiFi technology for transmitting traffic information to motor vehicles which have a LiFi-enabled receiving device and can process the information data is known from KR 100908915 B1.

### SUMMARY

A first object of the present disclosure is to provide an advantageous method and the associated devices for transmitting software-updating data to a motor vehicle by means of a LiFi transmission. Lifi transmission uses visible light to communicate in bidirectional, high-speed, and networked wireless technology. In addition, a second object of the present disclosure is to provide an advantageous motor vehicle, which is designed to receive and process the software-updating data transmitted via LiFi. A third object of the present disclosure is to provide an advantageous use of a LiFi-enabled traffic management system.

The present disclosure discloses a method for updating software of a motor vehicle by transmitting software-updating data via LiFi. The method uses a traffic management system, which comprises a plurality of LiFi-enabled transceiver modules. The method furthermore uses a LiFi-enabled transceiver module of the motor vehicle. The method disclosed in the present disclosure is carried out during the operation of the motor vehicle in road traffic. The software-updating data are transmitted from at least one of the LiFi-enabled transceiver modules of the traffic management system to the LiFi-enabled transceiver module of the motor vehicle located within the transmission range of the transceiver module.

For purely practical reasons, the updating of software of a motor vehicle in operation in road traffic is possible today only by means of a wireless connection. The transmission type most frequently used in road traffic for transmitting data to a motor vehicle is on-air technology. Due to the increased use of on-air technology in road traffic and at the locations close to the road traffic, the use of on-air technology is unsuitable for a software update of a motor vehicle. On the one hand, it is known that the download speed of an on-air transmission is only moderate. However, fast transmission rates are advantageous in road traffic with a dynamic movement of motor vehicles and short stopping times. The present disclosure proposes a flash process in public road traffic that provides LiFi technology as the basis for transmitting software-updating files.

According to one design of the method according to the disclosure, a route of the motor vehicle is defined in a navigation system and transferred to the traffic management system. The software-updating data are subdivided into data packets. The LiFi-enabled transceiver modules required for transmitting the data packets are selected along the route. The respective data packets are divided among the associated LiFi-enabled transceiver modules. The data packets are transmitted from the LiFi-enabled transceiver modules to the LiFi-enabled transceiver module of the motor vehicle.

According to a further design, the method in each case estimates the time spent by the motor vehicle within the transmission range of one of the selected transceiver modules using position data of the motor vehicle calculated by the navigation system. The method is furthermore designed in such a way that the subdivision of the software-updating data into data packets is performed depending on the estimated times spent. The size and/or the number of the individual data packets is adapted here to the time spent by the motor vehicle within the transmission range of the transceiver module of the traffic management system provided for the transmission of the data packet.

The navigation system supplies position data and trip data of the motor vehicle to the traffic management system. By matching the position data of the motor vehicle with location data of the transceiver modules, the transceiver modules can be defined along a route. The supplied trip data of the motor vehicle serve to calculate the times spent by the motor vehicle at specific locations, also including the location data of the transceiver modules. The respective time spent, together with the download speed, serves to define the file size of the data packets, or the number of data packets to be transmitted for the respective transceiver module.

According to a further design of the method, the data packets are subdivided into data blocks. During the transmission of a new data packet, the last data blocks of the preceding data packet are matched.

The matching of the last data blocks of the preceding data packet helps to ensure that the sequence of the data blocks is maintained and no data loss occurs.

According to a further design of the method, the complete download of the data packets for an update of the software of the motor vehicle is confirmed by a completion module of the motor vehicle. The design is furthermore configured so that the software-updating data are allocated to a motor vehicle component to be updated.

According to a further design of the method, the updating of the software of the motor vehicle is triggered by a further data packet transmitted via LiFi following the confirmation of the complete download.

The update of the software of the motor vehicle is preferably triggered by a further data packet transmitted via LiFi. Alternatively, the update can also be triggered manually by the driver.

According to a further design of the method, the update of the software of the motor vehicle is triggered depending on parameter values of the motor vehicle. For example, it is possible to start the update if the vehicle is parked and the engine is switched off.

Furthermore, combinations of the individual trigger forms for the update of the software of a motor vehicle are possible.

According to the disclosure, an updating device for a motor vehicle is provided to carry out the method according to the disclosure or its further designs. This updating device comprises a LiFi-enabled transceiver module that is designed to receive LiFi data transmitted via LiFi from a LiFi-enabled transceiver module of the traffic management system. Furthermore, the updating device comprises a detection module that is designed to filter out an identifier allocated to the motor vehicle in the incoming LiFi data and detect at least one software update for the motor vehicle.

The LiFi-enabled transceiver module of a motor vehicle is designed, on the one hand, to receive LiFi data from a traffic management system and, on the other hand, to transmit LiFi data to a traffic management system.

The updating device in a motor vehicle detects an incoming request for a software update for a specific system of the motor vehicle by means of the LiFi-enabled transceiver module.

According to one design, the updating device has an identification module that is designed to identify the motor vehicle to the transceiver module of the traffic management system. Furthermore, the design may have a confirmation module that is designed to confirm the completed download of the respective data packet. Furthermore, the design may have an allocation module that is designed to allocate the software-updating data to a motor vehicle component to be updated.

In the case of a multiplicity of motor vehicles in public road traffic, the allocation of the software-updating data to a specific motor vehicle is difficult. An identification of the motor vehicle to the traffic management system is required here in order to allocate the software-updating data to the respective motor vehicle.

According to a further design, the updating device has a completion module that is designed to confirm the downloading of all software-updating data.

With the confirmation of the completion of the downloading of all software-updating data, it is ensured that an update of the software of the respective motor vehicle component can be performed correctly.

According to one design, the updating device has a trigger module that is designed to trigger an update of the software of the motor vehicle with a further data packet transmitted via LiFi.

According to a further design, the trigger module is designed to trigger the updating of software of a motor vehicle depending on parameter values of the motor vehicle.

Following the confirmation of the download of all software-updating data for the updating of the software of a motor vehicle component, the software update can be triggered in different ways, on the one hand, by a further LiFi data packet, on the other hand, depending on parameter values of the motor vehicle, or by the combination of both. For example, the software of a motor vehicle component can be updated only when the motor vehicle is stationary, i.e. when it is parked (e.g. parameter_parking=0), the engine is switched off (e.g. parameter_engine=0) and the ignition key is removed (e.g. parameter_ignition_key=0).

According to a further design, the updating device has an information module that is designed to inform the driver of uncompleted software updates.

The software update of a motor vehicle component of the motor vehicle can be deferred in cases where it does not seem appropriate to perform an update, for example on journeys in sparsely populated areas with no or only a small number of transceiver modules. The driver of the motor vehicle can be informed of the still pending update at a predefined interval.

A transmission system for a traffic management system is provided in order to carry out the method according to the disclosure. This transmission system comprises a plurality of LiFi-enabled transceiver modules, in which location data are allocated in the traffic management system.

The transceiver modules are designed, on the one hand, to forward LiFi data to a motor vehicle and, on the other hand, to receive LiFi data from a motor vehicle.

According to one design, the transmission system has a division module that is designed to subdivide the software-updating data stored for transmission to a motor vehicle into data packets. Furthermore, the design has a distribution module that is designed to distribute the data packets among at least one transmitting device.

A motor vehicle in public road traffic is usually in constant movement. The stopping times are short and a motor vehicle does not usually spend much time within the transmission range of a transceiver module. It is, therefore, appropriate to subdivide the software-updating data into smaller data packets and distribute them among the corresponding transceiver modules.

According to one design, the transmission system has a receiving module that is designed to receive the position data calculated by a navigation system for a motor vehicle along a route. The design furthermore has an assignment module that is designed to assign the calculated position data of the motor vehicle to the stored location data of the LiFi-enabled transceiver modules.

For an appropriate software update, it is necessary to notify the route of the motor vehicle to the traffic management system, to select the respective transceiver modules and to allocate the data packets to the individual transceiver modules along the route.

According to one design of the transmission system, the receiving module is designed to receive trip data calculated for a motor vehicle from a navigation system. Furthermore, the transmission system has a calculation module that is designed to calculate the individual times spent by the motor vehicle within the transmission ranges of the transceiver modules.

The size of the individual data packets or the number of data packets is dependent on how much time a motor vehicle spends within the transmission range of each transceiver module. The time spent by the motor vehicle within the transmission range of a transceiver module multiplied by the download speed determines the size of the data packet or the number of data packets for this transceiver module.

The trip data received by the receiving module of the transmission system are preferably the speed and the acceleration of the motor vehicle at each individual coordinate point along the route.

A motor vehicle with an updating device according to the disclosure is furthermore disclosed in the present disclosure.

According to one design, the LiFi-enabled transceiver module contained in the updating device is a front camera of the motor vehicle.

The present disclosure furthermore claims a use according to the disclosure of a traffic management system with LiFi-enabled transceiver modules to carry out the method according to the disclosure for updating software of a motor vehicle according to the disclosure or its designs.

Moreover, the present disclosure provides a traffic management system, in which the LiFi-enabled transceiver modules comprise lighting units of the traffic management system.

According to one design of the present disclosure, a traffic management system is claimed, the LiFi-enabled transceiver modules of which comprise traffic lights.

Further features, characteristics and advantages of the present disclosure are set out in the following description of an example embodiment, with reference to the attached drawings.

### BRIEF DESCRIPTION OF THE DRAWINGS

FIG. 1 shows an example of a schematic representation of a motor vehicle according to the disclosure in road traffic during an updating of software of the motor vehicle by the traffic management system according to the disclosure.

FIG. 2 shows an example of a schematic structure of an updating device according to the disclosure.

FIG. 3 shows an example of a schematic structure of a transmission system according to the disclosure.

FIG. 4 shows an example of a procedure for identifying a motor vehicle according to the disclosure to a traffic management system according to the disclosure.

FIG. 5 shows an example of the method steps for a software update of a motor vehicle according to the disclosure in a traffic management system according to the disclosure.

### DETAILED DESCRIPTION

As required, detailed embodiments of the present disclosure are disclosed herein; however, it is to be understood that the disclosed embodiments are merely exemplary of the disclosure that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure.

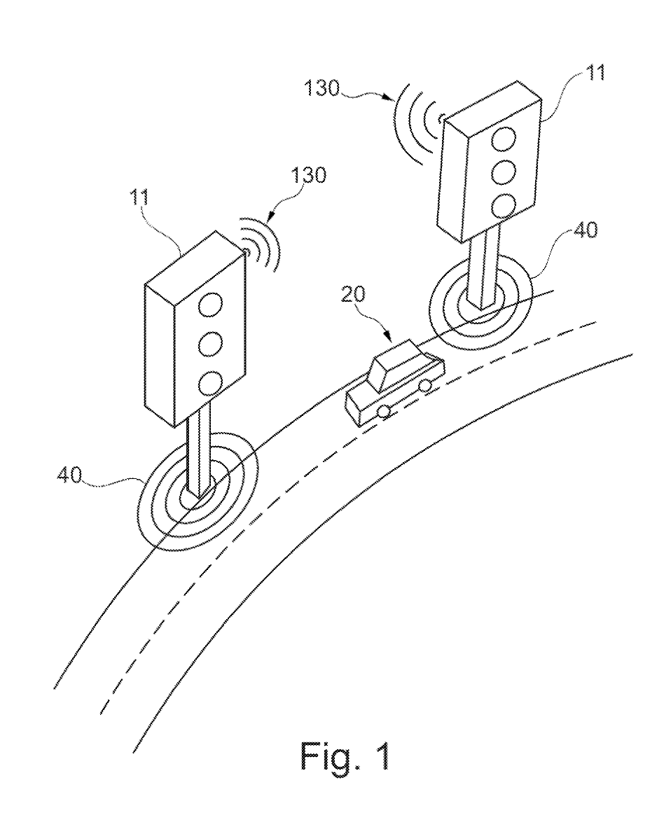

An example embodiment of a method for updating software of a motor vehicle 20 according to the disclosure by transmitting software-updating data 100 via LiFi using a traffic management system 10 are described below with reference to FIGS. 1 to 5.

The present disclosure provides a method that enables an updating of software of a motor vehicle 20. The special feature of this method is that the updating of the software of the motor vehicle 20 is performed directly in road traffic, as shown schematically in FIG. 1. The transceiver modules 11 necessary for transmitting the software-updating data 100 form part of a traffic management system 10. In the present example embodiment, the transceiver modules 11 are lighting units with LiFi-enabled receiving units, such as, for example, modified traffic lights. Alternatively, modified street lights or other modified signal-transmitting lighting units can also be used here. The software-updating data 100 are transmitted by means of LiFi technology. The updating of software of an individual motor vehicle 20 is difficult in public road traffic with a multiplicity of motor vehicles 20. For a trouble-free performance of the update, the motor vehicle 20 should identify itself to the traffic management system 10.

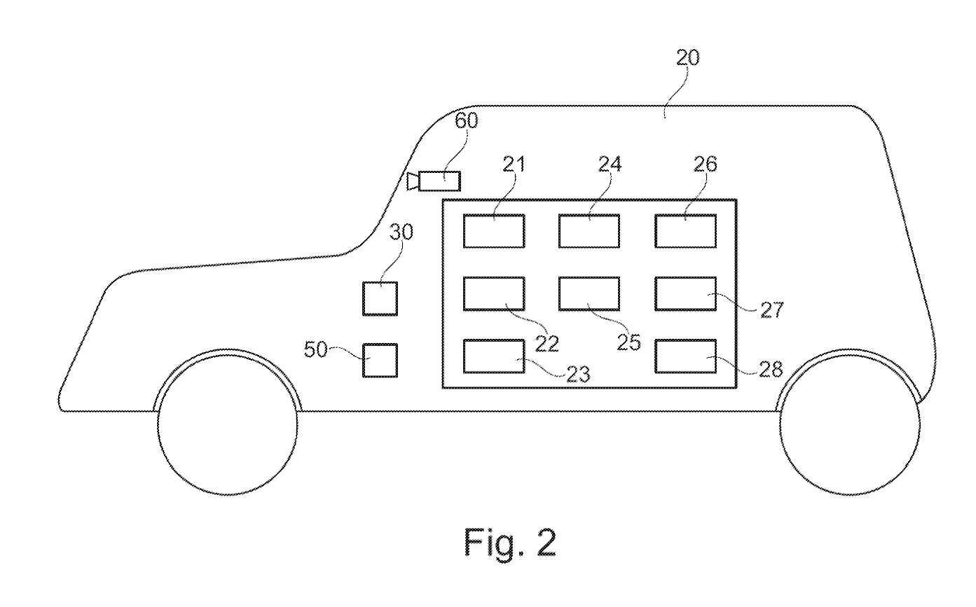

FIG. 2 schematically shows the structure of an updating device for a motor vehicle, which vehicle software can be updated via LiFi. The updating device comprises a transceiver module 21 that is configured to receive and transmit LiFi data packets 130. It furthermore comprises a detection module 22 that is configured to detect an identifier 120 in a set of LiFi data packets 130. The updating device furthermore comprises an identification module 23 that is configured to identify the motor vehicle 20 to the traffic management system 10. The updating device furthermore comprises a confirmation module 24 that is configured to confirm the completed download of individual LiFi data packets 130. The updating device also comprises an allocation module 25 that is configured to allocate the LiFi data packets 130 to the respective motor vehicle component 50 to be updated. The updating device furthermore comprises a completion module 26 that is configured to confirm the complete download of all LiFi data packets 130. The updating device furthermore comprises a trigger module 27 that is configured to trigger the updating of software of a motor vehicle component 50. If the update cannot be carried out, the updating device has an information module 28 that is configured to inform the driver of pending software updates.

In the example embodiment shown in FIG. 2, the navigation system 30 is disposed in the motor vehicle 20. Furthermore, in this example embodiment, a camera 60 for recording video signals containing LiFi data packets 130 is allocated to the transceiver module 21. The transceiver module 21 extracts the LiFi data packets 130 from the video signals.

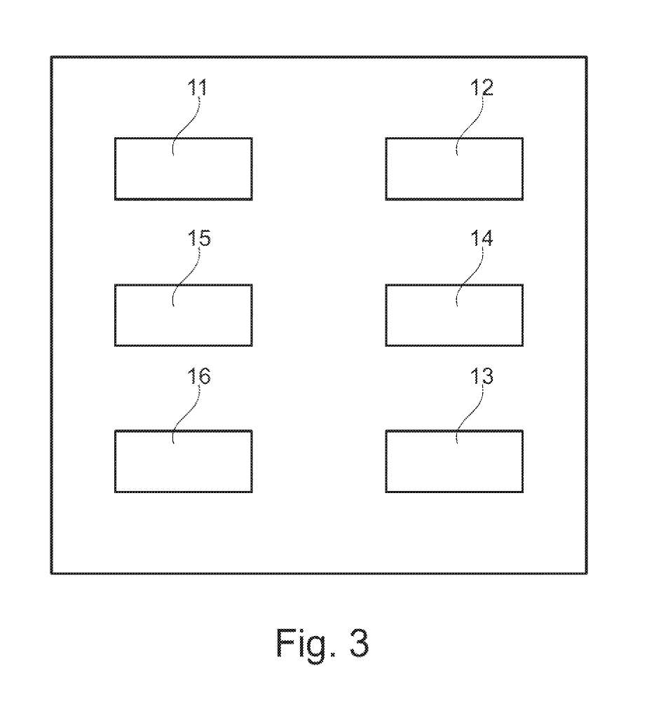

FIG. 3 schematically shows a transmission system for a traffic management system, which LiFi data for updating vehicle software can be transmitted to a motor vehicle. The transmission system comprises a transceiver module 11 that is designed to transmit and receive LiFi data packets 130. The transmission system comprises a receiving module 12 that is configured to receive the route 110, including the position data 112 and the trip data 113 of the motor vehicle 20, from the navigation system 30. The transmission system furthermore comprises a calculation module 13 that is designed to calculate the time spent by the motor vehicle 20 within the transmission range 40 of a transceiver module 11. The transmission system furthermore comprises an assignment module 14 that is configured to assign the position data 112 of the motor vehicle 20 to the location data of the transceiver modules 11. The transmission system also comprises a division module 15 and a distribution module 16 that are designed such that the software-updating data 100 are divided into data packets, and distributed among the individual transceiver modules 11.

It should be noted that the modules shown in the figures may be designed as hardware components and/or as software components.

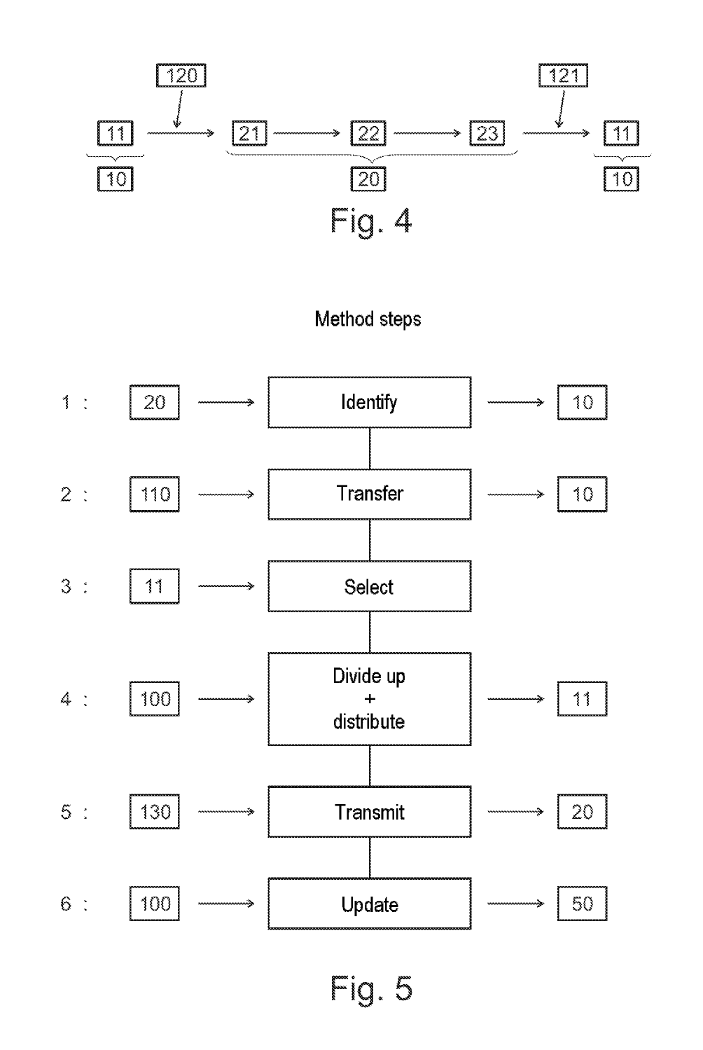

A procedure for identifying a motor vehicle 20 to the traffic management system 10 in a first method step is shown in FIG. 4. Although described as sequential, the steps of the disclosure may be performed in any manner, which achieves the objects of the present disclosure.

In the first method step, a transceiver module 11 of the traffic management system 10 transmits data via LiFi to the multiplicity of motor vehicles 20 in order to identify a motor vehicle 20 to the traffic management system 10. These transmitted LiFi data contain identification data 120 for individual vehicles, which requires an update for individual motor vehicle components 28. Here, the motor vehicles 20, equipped with a LiFi-enabled transceiver module 21, are located within the transmission range 40 of at least one transceiver module 11 of the traffic management system 10. The identification data 120 transmitted via LiFi are received by the transceiver module 21 of the motor vehicle 20, and forwarded to the detection module 22. In the motor vehicle 20, the identifier of said motor vehicle 20 is matched with the identifier 120 from the data transmitted via LiFi. In the event of a positive match, the identification module 23 transmits a data packet via LiFi to the traffic management system 10. The identification 121 of the motor vehicle 20 to the traffic management system 10 is contained in this data packet. The motor vehicle 20 can now receive the software-updating data 100.

In the second method step, communication takes place between the traffic management system 10 and a navigation system 30, which is allocated to the motor vehicle 20. It is irrelevant here whether the navigation system 30 is located in the traffic management system 10 or in the motor vehicle 20 itself. The navigation system 30 is preferably located in the motor vehicle 20. Alternatively, particularly if autonomously driving motor vehicles 20 are to have their software updated, the navigation system 30 is preferably located in the traffic management system 10. In the second method step, the navigation system 30 transfers a route 120 of the motor vehicle 20 to the traffic management system 10.

The receiving module 12 of the traffic management system 10 forwards the data to the assignment module 14 and the calculation module 13. The data supplied by the navigation system 30 contain the position data 112 and the trip data 113 of the motor vehicle 20 along a route 110. The speed and the acceleration of the motor vehicle 20, for example, are cited here as trip data 113.

In the third method step, the position data 112 of the motor vehicle 20 along the route 110 are further processed by the assignment module 14. The assignment module 14 assigns the position data 112 of the motor vehicle 20 to the location data of the transceiver modules 11 along the route 110. It is evident here that the allocation of the individual position data 112 of the motor vehicle 20 to the location data of the LiFi-enabled transceiver modules 11 of the traffic management system 10 is dependent on the density of the transceiver modules 11 along the route 110. In the dense road network of a city, it is possible to allocate each position 112 of the motor vehicle 20 along the route 110 to a transceiver module 11. In rural areas with few lighting units, the allocation of all position data 112 of the motor vehicle 20 to the location data of the LiFi-enabled transceiver modules 11 is not possible.

In the fourth method step, the calculation module 13 can calculate the time spent by the motor vehicle 20 at each individual LiFi-enabled transceiver module 11 along the route 110 from the individual position data 112 and the trip data 113 of the motor vehicle 20 along the route 110.

The software-updating data 100 are divided up into data packets on the basis of the number of LiFi-enabled transceiver modules 11 along the route 110 and the time spent by the motor vehicle 20 within the transmission range 40 of the respective transceiver module 11. One advantage of the present disclosure is the updating of the software in public road traffic. Since the motor vehicle 20 moves dynamically and has only a few stopping times, it is difficult to transmit the software-updating data 100 via a single LiFi-enabled transceiver module 11. A division among a plurality of transceiver modules 11 is required, particularly in the case of substantial quantities of software-updating data. For this division, it is necessary for the traffic management system 10, on the one hand, to know the position 112 of the motor vehicle 20 along the route 110 and, on the other hand, to receive the information indicating how long the motor vehicle 20 remains within the transmission range 40 of the respective transceiver module 11. With this data set, the traffic management system 10 can allocate a data packet 130 or a number of data packets 130 to each LiFi-enabled transceiver module 11, the size and number of said data packets being dependent on the time spent by the motor vehicle 20 within the transmission range 40 of the respective transceiver module 11. The individual data packets 130 are allocated to the LiFi-enabled transceiver modules 11 of the traffic management system 10 via the distribution module 16 of the traffic management system 10.

After the data packets 130 have been allocated to the transceiver modules 11, the transmission of the data packets 130 is coordinated by the traffic management system 10 in such a way that the individual data packets 130 are transmitted only if the motor vehicle 20 is located within the transmission range 40 of the respective transceiver module 11.

In the fifth method step, the data packets 130 are transmitted via LiFi to the motor vehicle 20 along the route 110. An identification 121 of the motor vehicle 20 to the traffic management system 10 takes place whenever a new transceiver module 11 is used. This ensures the involvement of the correct motor vehicle 20 that is intended to receive an update.

After the motor vehicle has identified itself to the traffic management system 10 at each individual transceiver module 11, the transceiver module 11 transmits the data packet(s) 130 allocated to it. The data packets 130 are subdivided into data blocks in order to guarantee a correct sequence of the data packets 130 and minimize the possibility of a data loss. The last data blocks of the preceding data packet 130 are matched between the motor vehicle 20 and the traffic management system 10 before the new data packet 130 is transmitted.

The data packets 130 transmitted via LiFi are received by the LiFi-enabled transceiver module 21 of the motor vehicle 20, and forwarded to an allocation module 25. In parallel, a confirmation 122 is transmitted to the traffic management system 10, indicating that the data packet 130 has been completely downloaded. The allocation module 25 allocates the individual data packet 130 to a motor vehicle component 50 that is to be updated.

The complete transmission of all data packets 130 results in the activation of the completion module 26 in the motor vehicle 20. The completion module 26 transmits a confirmation of completion 123 via LiFi to the traffic management system 10, so that the traffic management system 10 receives the information indicating that the software-updating data 100 have been transferred completely to the motor vehicle 20.

In the sixth method step, the traffic management system 10 transfers a data packet 140 responsible for triggering the update. The data packet 140 transmitted by the transceiver module 11 of the traffic management system 10 is received by the transceiver module 21 of the motor vehicle 20, and forwarded to the trigger module 27 of the motor vehicle 20. However, it must be noted that the update is not triggered instantaneously. The update is preferably triggered in key-off mode. In key-off mode, the motor vehicle 20 is parked and the engine is switched off. Furthermore, the update is preferably triggered automatically. Alternatively, it is possible for a driver of the motor vehicle 20 to trigger the update.

A schematic overview of the aforementioned method steps, described individually in detail, is shown in FIG. 5. The overview in FIG. 5 summarizes the method steps:

Identifying the motor vehicle 20 to the traffic management system 10;

Transferring the route 110 to the traffic management system 10;

Selecting the transceiver modules 11 along the route 110;

Dividing up the software-updating data 100 and distributing them among the transceiver modules 11;

Transmitting the data packets 130 via LiFi to the motor vehicle 20;

Updating the motor vehicle component 50.

In the example embodiment described, the LiFi-enabled transceiver module 21 that is used is a front camera 60 of the motor vehicle 20.

The present disclosure has been explained in detail for illustrative purposes on the basis of one example embodiment. However, a person skilled in the art will recognize that deviations from the example embodiment are possible. Thus, for example, a receiving range of the front camera 60 can be extended by a receiving range of a reversing camera, or the front camera 60 can be replaced by the reversing camera. However, it is equally possible to use a different, outwardly directed camera of the motor vehicle 20. Particularly, in a further embodiment, communication between the motor vehicle 20 and the traffic management system 10 can be implemented, on the one hand, by integrating the LiFi-enabled transceiver modules 11 of the traffic management system 10 into the crash barriers, or in the delimitation post and, on the other hand, by integrating the LiFi-enabled transceiver module 21 of the motor vehicle 20 into the wing mirror housing.

While exemplary embodiments are described above, it is not intended that these embodiments describe all possible forms of the disclosure. Rather, the words used in the specification are words of description rather than limitation, and it is understood that various changes may be made without departing from the spirit and scope of the disclosure. Additionally, the features of various implementing embodiments may be combined to form further embodiments of the disclosure.

What is claimed is:

1. A software update method for a vehicle, comprising:
transmitting software-updating data, during operation of a vehicle in road traffic, using a traffic management system having a plurality of LiFi enabled transceiver modules, and a LiFi-enabled transceiver module of the vehicle,
wherein software-updating data are transmitted from at least one of the transceiver modules of the traffic management system to the vehicle transceiver module located within a transmission range of the at least one of the transceiver modules.

2. The method as claimed in claim 1 further comprising:
defining a route in a navigation system;
transferring the route to the traffic management system;
subdividing software-updating data into data packets; and
selecting the transceiver modules required for transmitting data packets along the route such that respective data packets are divided among associated transceiver modules,
wherein data packets are transmitted from the transceiver modules to the vehicle transceiver module.

3. The method as claimed in claim 2 further comprising:
estimating a time spent by the vehicle within the transmission range of one of the selected transceiver modules using vehicle position data calculated by the navigation system; and
subdividing software-updating data into data packets depending on the estimated time spent,
wherein size and/or number of individual data packets to be transmitted by a transceiver module of the traffic management system is adapted to the time spent by the vehicle within the transmission range.

4. The method as claimed in claim 3 further comprising subdividing data packets into data blocks, such that, during transmission of a new data packet, a last data block of the data blocks from a preceding data packet are matched.

5. The method as claimed in claim 4 further comprising:
confirming a complete download of data packets for an update of software by a completion module; and
allocating software-updating data to a vehicle component.

6. The method as claimed in claim 5 further comprising triggering updating software by a further data packet transmitted via LiFi following confirmation of the complete download.

7. The method as claimed in claim 5, wherein triggering updating software depends on parameter values of the vehicle.

8. An updating device for a vehicle, comprising:
a LiFi-enabled vehicle transceiver module configured to receive LiFi data transmitted via LiFi from a LiFi-enabled system transceiver module; and
a detection module configured to filter out an identifier allocated to the vehicle in incoming LiFi data, and detect at least one software update for the vehicle.

9. The updating device as claimed in claim 8 further comprising:
an identification module configured to identify the vehicle to the system transceiver module;
a confirmation module configured to confirm a completed download of a respective data packet; and
an allocation module configured to allocate updating data to a vehicle component to be updated.

10. The updating device as claimed in claim 9 further comprising a completion module configured to confirm downloading of all software-updating data.

11. The updating device as claimed in claim 10 further comprising a trigger module configured to trigger a vehicle software update via a further data packet transmitted via LiFi.

12. The updating device as claimed in claim 10, further comprising a trigger module configured to trigger updating of vehicle software depending on parameter values of the vehicle.

13. The updating device as claimed in claim 11 further comprising an information module configured to inform a driver of uncompleted software updates.

14. A vehicle, comprising:
a plurality of LiFi-enabled transceiver modules configured to receive LiFi data transmitted from a LiFi-enabled traffic-management system transceiver module; and
a detection module configured to filter out an identifier in incoming LiFi data, and detect at least one software update,
wherein location data are allocated in a traffic management system;

15. The vehicle as claimed in claim 14 further comprising:
a division module configured to subdivide software-updating data stored for transmission into data packets; and
a distribution module configured to distribute data packets among at least one of the plurality of LiFi-enabled transceiver modules.

16. The vehicle as claimed in claim 15 further comprising
a receiving module configured to receive position data calculated by a navigation system along a route; and
an assignment module configured to assign calculated position data to stored location data of the LiFi-enabled transceiver modules.

17. The vehicle as claimed in claim 16, wherein the receiving module further configured to receive trip data calculated by the navigation system.

18. The vehicle as claimed in claim 16 further comprising a calculation module configured to calculate individual times within transmission ranges of the transceiver modules.

19. The vehicle as claimed in claim 14, wherein the plurality of LiFi-enabled transceiver modules comprises a front camera.

20. The vehicle as claimed in claim 14, wherein the LiFi-enabled transceiver modules comprise lighting units of the traffic management system.
